(19) United States
(12) Patent Application Publication
(10) Pub. No.: US 2004/0036349 A1
(43) Pub. Date: Feb. 26, 2004

(54) One-touch vehicle braking system for temporary halting a motored vehicle at a traffic stop

(76) Inventor: Meiyin Lin, Novi, MI (US)

Correspondence Address: Meiyin Lin, 24294 Lynwood Dr., Novi, MI, 48374, US

(21) Appl. No.: 10/223,731

(22) Filed: Aug. 20, 2002

(51) Int. Cl. B60T 7/00

(52) U.S. Cl. 303/15

(57) ABSTRACT

A one-touch braking system that operates the vehicle's braking system and controls the: transmission relieves a vehicle operator from having to continuously press one foot on the brake pedal all the time during a traffic stop. When used in a motored vehicle equipped with an automatic transmission, this one-touch braking system shifts the transmission to “Park”, from “Drive” mode at the traffic stop to improve fuel economy, durability, and NVH (noise, vibration, and harshness) by reducing the internal friction in the transmission and the transmission load to the engine. When implemented in a vehicle with a manual transmission, this one-touch braking system also automatically operates the transmission clutch to assist the vehicle operator at a traffic stop.

### BACKGROUND

1. Field of Invention

When a motor vehicle equipped with an internal combustion engine and an automatic transmission stops at a traffic light, at a railroad crossing, or in a traffic jam the vehicle operator usually presses his/her foot on the brake pedal while waiting. During this waiting period, the operator cannot remove his/her foot from the brake pedal or the vehicle may move ahead and hit the vehicle in front or run into the crossing traffic. This traffic stop situation is not only annoying but also causes fatigue to the operator especially for frequent stop and go vehicle operations and is a potential safety issue.

Another concern with this traffic stop situation is that after the vehicle is brought to a full stop with the operator's foot pressing on the brake pedal, the vehicle is in the “Drive” mode and the engine is still running and driving the internal components of the automatic transmission. This causes excessive friction, generates heat, produces wear, and makes noise and vibration in the transmission. Because the engine needs to drive this transmission as an external load, the engine also burns more fuel than it does without the transmission load.

The operator does have an option of shifting the automatic transmission from “Drive” to “Park” mode after the vehicle is brought to a full stop. But this operation is inconvenient for the operator to do frequently that most vehicle operators choose not to do that even though the engine burns less fuel at the “Park” mode and there is less internal friction, wear, noise, and vibration in the transmission.

It is even more inconvenient for a motored vehicle equipped with a manual transmission that the operator will need to not only continuously keep his/her foot on the brake pedal but also shift the transmission to the “neutral” mode or continuously keep his/her other foot on the clutch pedal all the time at the traffic stop.

2. Description of Prior Art

The current state-of-the-art technology for keeping a motored vehicle from moving at a traffic light, at a railroad crossing, or in a traffic jam requires the operator to continuously press his/her foot on the brake pedal or shift the transmission to “Park” mode for an automatic transmission-equipped vehicle. If the vehicle is equipped with a manual transmission then the driver has two options: he/she may continuously press one foot on the brake pedal and another foot on the clutch pedal; or he/she may place one foot on the brake pedal and use another foot to operate the clutch pedal to shift the transmission to the “Neutral” mode to securely hold the vehicle from moving.

The problems with the current technology are:

It makes the vehicle operator tired if he/she needs to press his/her foot on the brake pedal for an extended period. It is even worse with a manual transmission-equipped vehicle because the operator also needs to continuously press his/her foot on the clutch pedal or be bothered with pressing down the clutch pedal and shifting the transmission to “Neutral” mode

It is more likely to cause a traffic accident since the vehicle operator may move his/her foot from the brake pedal unintentionally—the vehicle will move forward and hit the vehicle in front or, even worse, run into the crossing traffic.

If the vehicle operator chooses to just press down on the brake pedal without shifting the automatic transmission from “Drive” to “Park,” which is the case for most vehicle operators, the transmission stays in the “Drive” mode and the engine keeps on driving the transmission's internal parts that causes excessive friction, noise, and wear on parts. The engine will also burn more fuel to drive the transmission as an external load.

### OBJECTS AND ADVANTAGES

This one-touch braking system offers a convenience feature to a vehicle operator. It relieves the operator from being required to continuously press his/her foot on the brake pedal when the vehicle is at a traffic stop for an automatic transmission-equipped vehicle. It also frees the operators from being required to continuously press his/her foot on the clutch pedal or operating the clutch pedal and shifting the transmission to the “Neutral” mode for a manual transmission-equipped vehicle. When the vehicle is to move ahead, this one-touch braking system automatically shifts the transmission gear from “Park” to “Drive” when the accelerator pedal is pressed for an automatic transmission-equipped vehicle. For a manual transmission-equipped vehicle, this one-touch braking system also automatically operates the clutch in coordination with the operation of the accelerator pedal.

This one-touch braking system adds a safety feature to benefit the motored vehicle operator. It positively engages the braking system of a vehicle at the traffic stop so the vehicle will not move before the operator presses his/her foot on the accelerator pedal. It eliminates the hazardous possibility that the operator accidentally removes his/her foot from the brake pedal that may cause the vehicle moves forward and hits the vehicle in front or, in a much worse situation, runs into the crossing traffic.

This one-touch braking system also improves the fuel economy and durability of a motored vehicle. It automatically shifts the automatic transmission into “Park” mode from “Drive” mode when the brake pedal is pressed down at a traffic stop. This disengages the internal components of the automatic transmission as an external load from the engine and hence reduces fuel consumption of the engine. As by-products of this disengagement of the transmission from the engine, the wear of the transmission's internal components can be significantly reduced and the noise and vibration from the transmission's internal components are also eliminated.

Further objects and advantages of my invention will become apparent from a consideration of the drawings and ensuing description.

### BRIEF DESCRIPTION OF DRAWINGS

FIG. 1 shows the first preferred embodiment of the one-touch braking system for a motored vehicle with an automatic transmission. It has a brake actuator that controls the master cylinder of the vehicle's hydraulic braking system to operate the vehicle's brakes through a braking processing and control unit. The braking processing and control unit also controls the gear shifting of the automatic transmission.

FIG. 2 shows the second preferred embodiment of this invention in which the brake actuator operates the service brake instead of the vehicle's hydraulic braking system as shown in FIG. 1.

FIG. 3 shows the third preferred embodiment of this one-touch braking system for a motored vehicle with a manual transmission. It uses a braking processing and control unit to activate a brake actuator that controls the master cylinder of the vehicle's hydraulic braking system and a clutch actuator that operates the clutch between the transmission and the engine. The braking processing and control unit also controls the release of the clutch via the clutch actuator in a coordinated manner based on the operation of the accelerator pedal when the vehicle operator presses on the accelerator pedal to move the vehicle.

FIG. 4 shows the fourth embodiment of the invention for a motored vehicle with a manual transmission that has a brake actuator controlling the service brake instead of the vehicle's hydraulic braking system as shown in FIG. 3.

FIG. 5 is the fifth embodiment of the one-touch braking system for a motored vehicle having a manual transmission with an automatic clutch, sometimes called “auto-shift” manual transmission. The braking processing and control unit controls the vehicle's hydraulic braking system and the automatic clutch to halt the vehicle from moving at a traffic stop. The braking processing and control unit also releases the automatic clutch in coordination with the operation of the accelerator pedal when the vehicle operator wants to move the vehicle.

FIG. 6 shows the sixth embodiment of the invention that has a brake actuator controlling the service brake instead of the vehicle's hydraulic braking system as shown in FIG. 5.

FIG. 7 shows the seventh preferred embodiment of this one-touch braking system for a motored vehicle with a “stop-start” feature. The braking processing and control unit uses a brake actuator to operate the vehicle's hydraulic brake master cylinder to activate the vehicle's braking system, just like the first embodiment for a vehicle with an automatic transmission as shown in FIG. 1. However, it deactivates the brake actuator and turns on the starter motor to launch the vehicle when the accelerator pedal is pressed. The start motor at the same time cranks the engine to start.

FIG. 8 shows the eighth preferred embodiment of this invention also for a motored vehicle with a “stop-start” feature. It is similar to the seventh embodiment except the brake actuator activates the service brake instead of the vehicle's hydraulic braking system.

FIG. 9 shows a steering wheel with a press button that can be easily accessed to activate the braking-system.

### REFERENCE NUMERALS IN DRAWINGS

1 Touch/press buttons

2 Braking processing and control unit

3 Brake pedal

4 Brake actuator

5 Hydraulic brake booster

6 Hydraulic master cylinder

7 Steering wheel

8 Service brake pedal

9 Service brake actuator

10 Engine

11 Clutch pedal

12 Clutch

13 Manual transmission

14 Clutch actuator

15 Automatic transmission

16 One-touch brake light

17 Position sensor

18 Service brake cable

20 Engine starter motor

22 Automatic clutch with actuator

23 Manual transmission with automatic clutch

24 Signal transmission line

25 Hydraulic brake line fluid in

26 Hydraulic brake line fluid out

### SUMMARY OF THE INVENTION

A one-touch braking system for a motored vehicle activates the braking system by one touch of a button to relieve a vehicle operator from having to continuously press his/her foot on the brake pedal at a traffic stop. The one-touch braking system also shifts the transmission gear to “Park” from “Drive” to reduce the internal friction, improve the wear, noise, and vibration in the automatic transmission, and save fuel the engine burns to drive the transmission in the “Drive” mode for a motored vehicle with an automatic transmission. For a motored vehicle with a manual transmission, the one-touch braking system activates the braking system and at the same time operates the clutch at the traffic stop to relieve the vehicle operator from having to press down both the brake and clutch pedals.

### DETAIL DESCRIPTIONS OF THE INVENTION

This invention is a one-touch motored vehicle braking system that activates the braking system of a vehicle without requiring the vehicle operator to press and hold the brake pedal down to keep the vehicle from moving at a traffic stop. This one-touch braking system can also control the transmission and engine operations to further secure the vehicle from moving and also improve the vehicle's fuel economy and reduce noise, vibration, and wear of the engine and transmission when the vehicle is at the traffic stop.

This one-touch braking system works when the vehicle operator presses a touch button after he/she presses his/her foot on the brake pedal to bring the vehicle to a full stop at a traffic stop. The vehicle operator can then remove his/her foot from the brake pedal while waiting. When it is time to move ahead, the operator just presses his/her foot on the accelerator pedal. The movement of the accelerator pedal causes a deactivation of the braking system and reset of the operations of the engine and transmission so the vehicle can move ahead as normal.

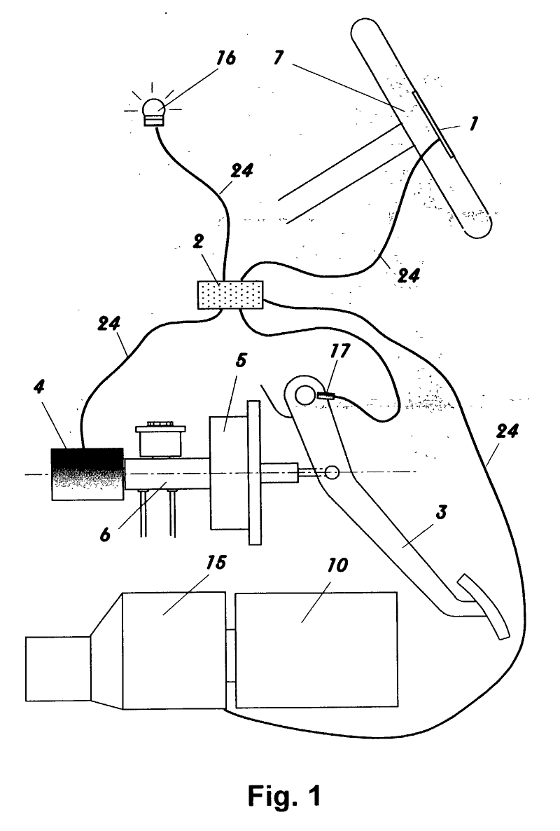

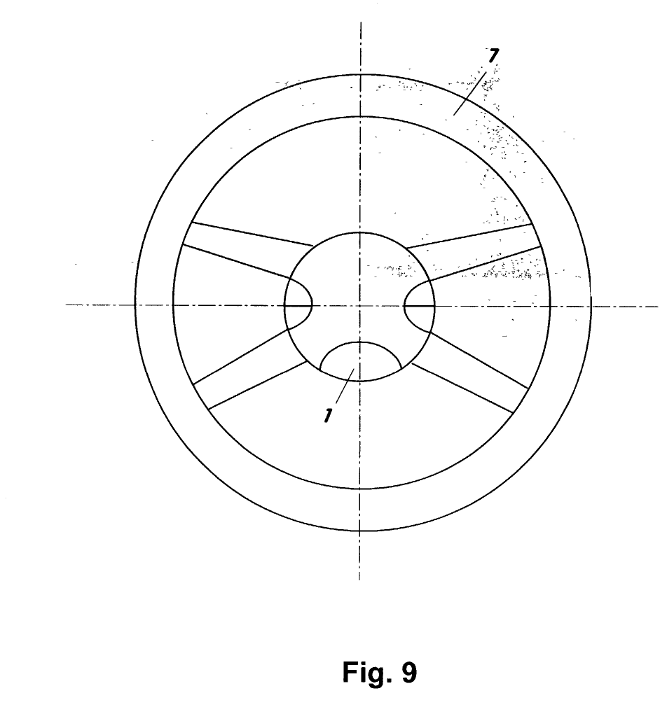

The first preferred embodiment of this one-touch braking system, as shown in FIG. 1, is for a motored vehicle with an automatic transmission. It has a press button 1 installed on the steering wheel 7, also as shown in FIG. 9 as one possible embodiment. When button 1 is pressed, a signal is sent through a signal transmission line 24 to a braking processing and control unit 2 which then checks if the operator presses his/her foot on the brake pedal 3 by checking the position of the brake pedal through a position sensor 17 and if the vehicle is fully stopped by a vehicle speed sensor. If both yes a brake actuator 4 is activated that operates the hydraulic braking system's master cylinder 6 to activate the vehicle's braking system. This braking processing and control unit 2 also sends a signal to control the vehicle's automatic transmission 15 to shift gears from the “Drive” to the “Park” mode, and turns on a one-touch braking system activation light 16 in the instrument panel. The operator now can remove his/her foot from the brake pedal without worrying the vehicle may move ahead.

When the operator presses his/her foot on the accelerator pedal an accelerator pedal position sensor, which is similar to the brake pedal position sensor 17 but is installed with the accelerator pedal, sends a signal to the braking processing and control unit 2. The braking processing and control unit 2 in turn sends a signal to control the automatic transmission 15 to shift the transmission from “Park” to “Drive” mode. The braking processing and control unit 2 also deactivates the brake actuator 4, causing the hydraulic master cylinder 6 returns to its' previous state to deactivate the vehicle's braking system and turns the braking system activation light 16 off. The vehicle is then ready to go.

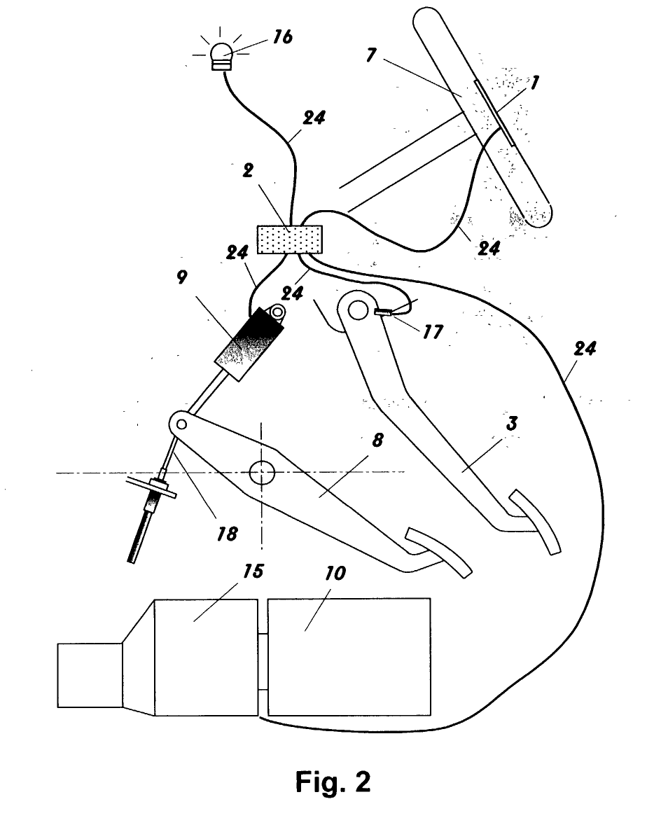

The second preferred embodiment of this one-touch braking system is also for a motored vehicle with an automatic transmission. It is similar to the first embodiment but using a brake actuator 9 to operate the service brake pedal 8, as shown in FIG. 2, instead of the master cylinder of the vehicle's hydraulic braking

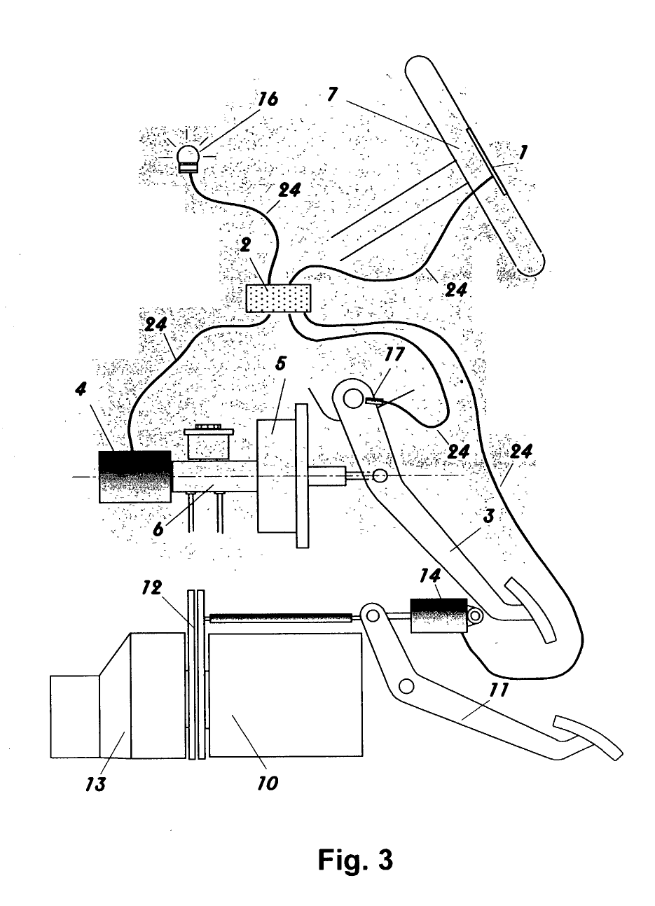

The third preferred embodiment of this one-touch braking system is for a motored vehicle with a manual transmission. It has a sensor 1 installed on the steering wheel 7, as shown in FIG. 3. When the sensor 1 is pressed a signal is sent through a signal transmission line 24 to the braking processing and control unit 2 which then checks if the operator presses his/her foot on the brake pedal 3 by checking the position of the brake pedal 3 through a position sensor 17 and if the vehicle is fully stopped. If both yes a clutch actuator 14 is activated that operates the vehicle's clutch 12 to disengage the manual transmission 13 from the engine 10 in a coordinated manner and a brake actuator 4 is activated that operates the vehicle's hydraulic braking system's master cylinder 6 to activate the braking system. This braking processing and control unit 2 also sends a signal to turns on a one-touch braking system light 16 in the instrument panel. The vehicle is now secured from moving and the operator can remove his/her feet from the brake and the clutch pedals.

When the operator presses his/her foot on the accelerator pedal, an accelerator pedal position sensor similar to the brake pedal position sensor 17 sends a signal to the braking processing and control unit 2 through a signal transmission line 24. The braking processing and control unit 2 then sends signals to deactivate the brake actuator 4 to disengage the vehicle's braking system and to operates the clutch actuator 14 to release the clutch 12 in a coordinated manner with the engine's throttle position controlled by the accelerator pedal. The braking processing and control unit 2 also turns the one-touch braking system activation light 16 off. The vehicle is ready to go at the operator's command.

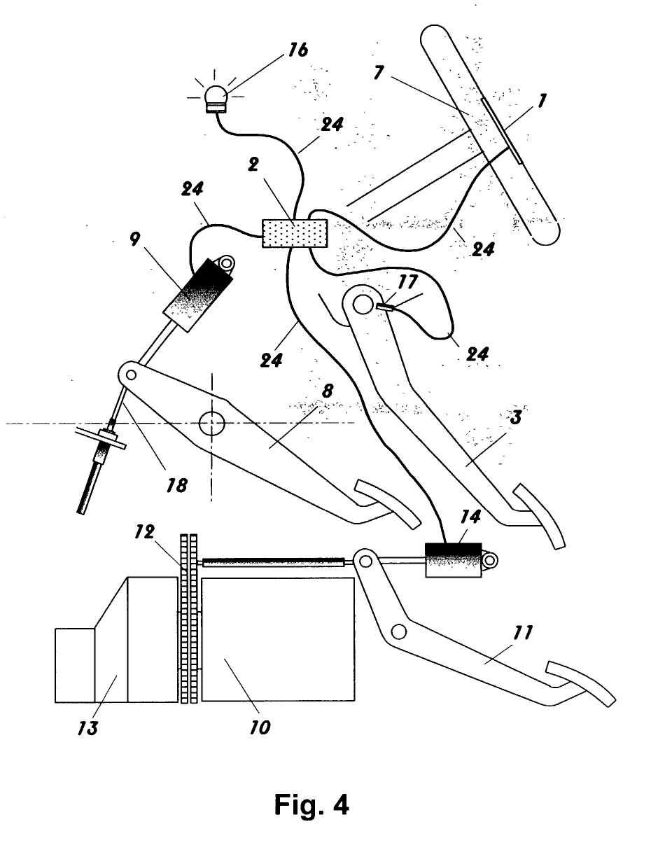

The fourth preferred embodiment of this one-touch braking system is also for a motored vehicle with a manual transmission. It is similar to the third embodiment except the brake actuator 9 is used to operate the service brake cable 18 through the service brake pedal 8, as shown in FIG. 4, instead of the hydraulic master cylinder of the vehicle's hydraulic braking system

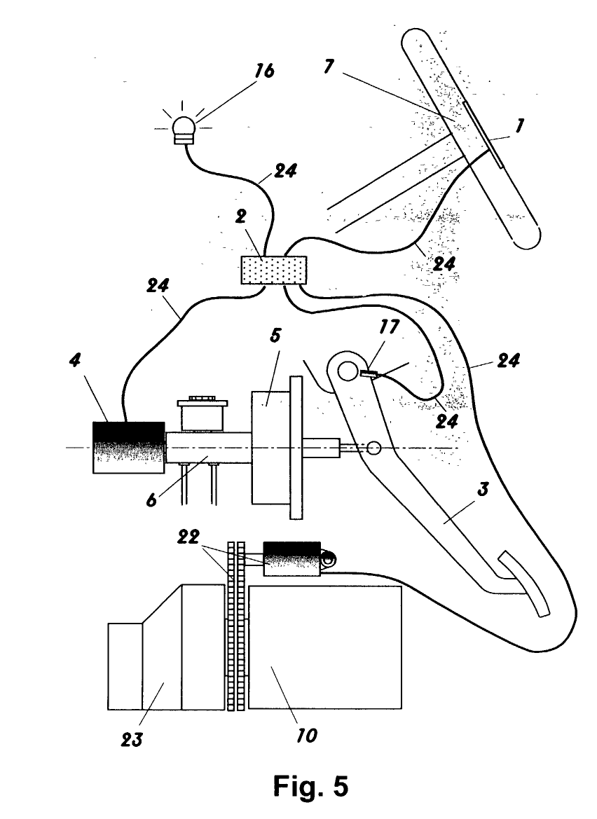

The fifth preferred embodiment of this one-touch braking system, as shown in is FIG. 5, is for a motored vehicle having a manual transmission with an automatic clutch. This type of manual transmission, sometimes called “auto-shift manual” transmission, has a hydraulically or electro-magnetically operated clutch 22 that engages and disengages the transmission 23 from the engine 10 in a predetermined and coordinated manner without a clutch pedal. When a touch sensor 1 is pressed, a signal is sent to a braking processing and control unit 2, which then checks if the operator presses his/her foot on the brake pedal 3 and if the vehicle is fully stopped. If both yes the braking processing and control unit 2 sends a signal to activate a brake actuator 4 to operate the braking system and a signal to the automatic clutch 22 to disengage the manual transmission 23 from the engine 10. This braking processing and control unit 2 also sends a signal to turn on a one-touch braking system light 16 in the instrument panel. The vehicle now is fully secured from moving and the operator can now remove his/her foot from the brake pedal.

When the operator presses his/her foot on the accelerator pedal 3, an accelerator pedal position sensor similar to the brake pedal position sensor 17 except installed to the accelerator pedal sends a signal to the braking processing and control unit 2. The braking processing and control unit 2 in turn sends a signal to the automatic clutch 22 to engage the transmission 23 to the engine 10 and a signal to deactivate the brake actuator 4 to release the vehicle's braking system. The braking processing and control unit 2 then sends a signal to turn the one-touch braking system activation light, 16 off. The vehicle is ready to go.

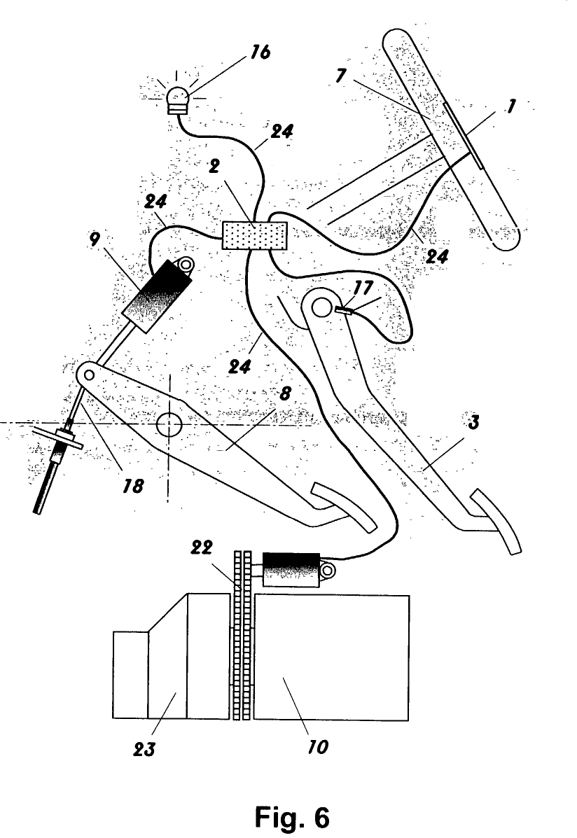

The sixth preferred embodiment of this one-touch braking system is also for a motored vehicle with an auto-shift manual transmission. It is similar to the fifth embodiment except the brake actuator 9 is used to operate the service brake cable 18 through the service brake pedal 8, as shown in FIG. 6, instead of the master cylinder of the vehicle's hydraulic braking system.

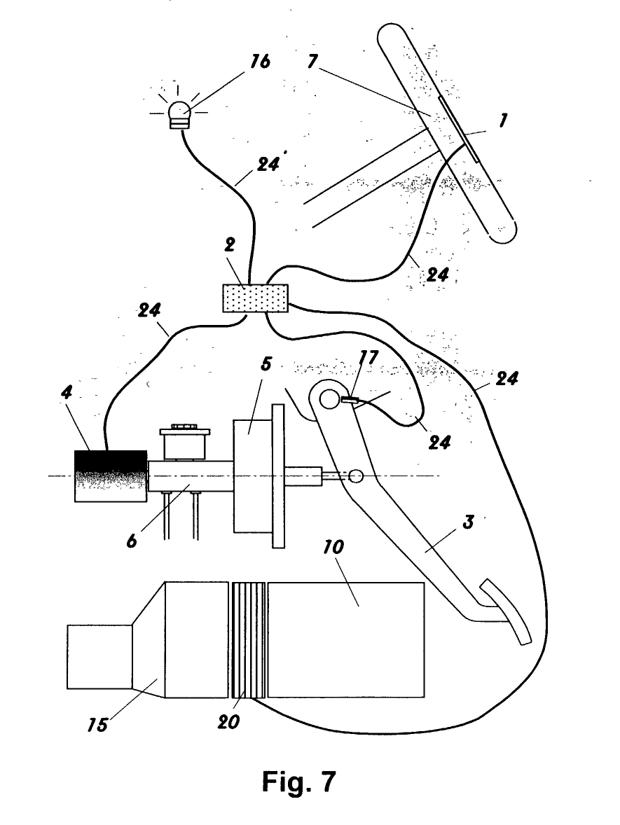

The seventh embodiment of this invention is for a motored vehicle with an automatic “stop-start” technology. This “stop-start” technology, as shown in FIG. 7, has an electrical starter motor 20 in place of the traditional starter motor for a conventional internal engine 10. When the vehicle stops at a traffic stop over a predetermined amount of time, the internal combustion engine 10 shuts down. When the vehicle is ready to go, the operator presses his/her foot on the accelerator pedal to activate the electrical starter motor 20. The electrical starter motor 20 drives the vehicle through an automatic transmission 15 and at the same time turns the engine's crankshaft to start the engine. This “start-stop” operation is said to have the potential of saving fuel by 5-10%.

In the embodiment for a motored vehicle with a “stop-start” feature, as shown in FIG. 7, the operator presses a touch button 1 to manually activate the “stop” mode. The braking processing and control unit 2, upon receiving the signal from the touch button 1, checks if the vehicle operator has pressed his/her foot on the brake pedal 3 and if the vehicle is fully stopped. If both yes then it sends a signal to shut down the engine 10 and sends another signal to the brake actuator 4 to operate the hydraulic master cylinder 6 to activate the vehicle's braking system. When the operator presses his/her foot on the accelerator pedal, a position sensor installed in the accelerator pedal sends a signal to the braking processing and control unit 2. The braking processing and control unit 2 then sends a signal to activate the starter motor 20 and another signal to deactivate the brake actuator 4 to disable the vehicle's braking system. The starter motor then drives the vehicle through the transmission 15 and at the same time cranks the engine 10 to start. The vehicle is ready to go.

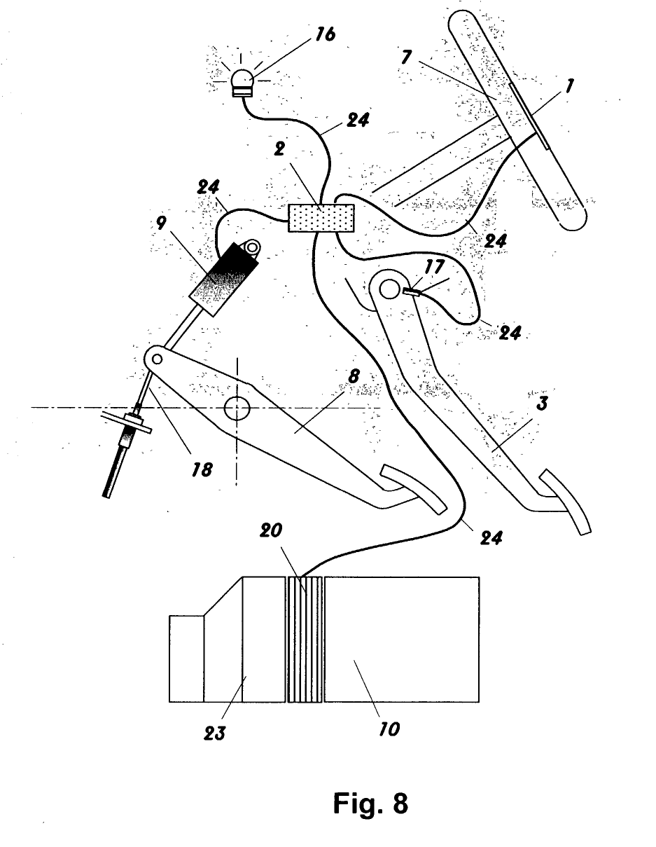

The eighth preferred embodiment of this one-touch braking system is also for a motored vehicle with an automatic “stop-start” feature. It is similar to the seventh embodiment but using the brake actuator 9 to operate the service brake cable 18 through the service brake pedal 8, as shown in FIG. 8, instead of the master cylinder of the vehicle's hydraulic braking system. When the vehicle operators press his/her foot on the accelerator pedal, the braking processing and control unit 2 sends a signal to deactivate the brake actuator 9 to release the service brake and another signal to activates the starter motor 20 to move the vehicle while at the same time the starter motor 20 cranks the engine 10 to start.

### CONCLUSION, RAMIFICATIONS, AND SCOPE

Thus the reader will see that the one-touch motored vehicle braking system of this invention provides a function that allows the operator of the vehicle to remove his/her foot from continuously pressing down the brake pedal at a traffic light at a railroad crossing, or in a traffic jam with a touch of a button. This one-touch braking system also lets the vehicle operator to simply step on the accelerator pedal to deactivate the braking system when the vehicle is ready to go.

While my above description contains many specificities, these should not be construed as limitations on the scope of the invention, but rather as an exemplification of some preferred embodiments thereof. Many other variations are possible.

For example, for a motored vehicle with an electrical braking system a preferred embodiment of this invention will have the braking processing and control unit controls the electrical brake actuators that are parts of the vehicle's braking system already instead of using an additional brake actuator to control the braking system through the hydraulic braking system's master cylinder.

I claim:

1. A one-touch braking system for a motored vehicle comprising:
(a). An one-touch braking switch means installed in a vehicle that is conveniently reachable by the operator of the vehicle and sends a braking initiation signal out to a braking processing and control means when switched on or sends a braking release signal out to said braking processing and control means when switched off
(b). An accelerator pedal position sensing means that detects if the accelerator pedal is pressed down and sends an accelerator pedal position signal to said braking processing and control means
(c). A brake pedal position sensing means that detects if the brake pedal is pressed down and sends a brake pedal position signal to said braking processing and control means
(d). A vehicle speed sensing means that detects the vehicle speed and sends a vehicle speed signal to said braking processing and control means
(e). Said braking processing and control means receives said one-touch braking signal, said accelerator pedal position signal, said brake pedal position signal, and said vehicle speed signal and checks if the brake pedal is being pressed down by the vehicle operator, the accelerator pedal is not being pressed down, and the vehicle speed is zero and if all yes then it sends a brake actuator activation signal to a brake actuation means upon receiving said braking initiation signal
(f). Said braking processing and control means receives said one-touch braking signal, said accelerator pedal position signal, said brake pedal position signal, and said vehicle speed signal and checks if the brake pedal is not being pressed down by the vehicle operator, the accelerator pedal is being pressed down and if all yes then it sends a brake deactivation signal to said brake actuation means upon receiving said brake release signal.
(g). Said brake actuation means activates the vehicle's braking system upon receiving said brake actuator activation signal or deactivates the vehicle's braking system upon receiving said brake actuator deactivation signal from said braking processing and control means.

2. A one-touch braking system for a motored vehicle, as stated in claim 1, wherein
(a). Said brake actuation means that operates the service brake system of the vehicle to activate the service brakes of the vehicle upon receiving said brake actuator activation signal or release the service brakes of the vehicle upon receiving said brake actuator deactivation signal from said braking processing and control means.

3. A one-touch braking system for a motored vehicle as stated in claim 1, wherein
(a). The vehicle's braking system is a hydraulic braking system
(b). Said brake actuation means operates the master cylinder of said hydraulic braking system of the vehicle to activate the brakes of the vehicle upon receiving said brake actuator activation signal or deactivate the brakes of the vehicle upon receiving said brake actuator deactivation signal from said braking processing and control means.

4. A one-touch braking system for a motored vehicle, as stated in claim 1, wherein
(a). The vehicle's braking system is an electric braking system
(b). Said brake actuation means is the same brake actuation means of said electrical braking system that activates the brakes of the vehicle upon receiving said brake actuator activation signal or release the brakes of the vehicle upon receiving said brake actuator deactivation signal from said braking processing and control means.

5. A one-touch braking system for a motored vehicle equipped with an automatic transmission comprising:
(a); An one-touch braking switch means installed in a vehicle that is conveniently reachable by the operator of the vehicle and sends a braking initiation signal out to as braking processing and control means when switched on or sends a braking release signal out to said braking processing and control means when switched off
(b). An accelerator pedal position sensing means that detects if the accelerator pedal is pressed down and sends an accelerator pedal position signal to said braking processing and control means
(c). A brake pedal position sensing means that detects if the brake pedal is pressed down and sends a brake pedal position signal to said braking processing and control means
(d). A vehicle speed sensing means that detects the vehicle speed and sends a vehicle speed signal to said braking processing and control means
(e). Said braking processing and control means receives said one-touch braking signal, said accelerator pedal position signal, said brake pedal position signal, and said vehicle speed signal and checks if the brake pedal is being pressed down by the vehicle operator, the accelerator pedal is not being pressed down, and the vehicle speed is zero and if all yes then it sends a brake actuator activation signal to a brake actuation means and an automatic transmission shift signal to an automatic transmission control means upon receiving said braking initiation signal
(f). Said braking processing and control means receives said one-touch braking signal, said accelerator pedal position signal, said brake pedal position signal, and said vehicle speed signal and checks if the brake pedal is not being pressed down by the vehicle operator, the accelerator pedal is being pressed down and if all yes then it sends a brake deactivation signal to said brake actuation means and an automatic transmission reset signal to said automatic transmission control means upon receiving said brake release signal.
(g). Said brake actuation means activates the vehicle's braking system upon receiving said brake actuator activation signal or deactivates the vehicle's braking system upon receiving said brake actuator deactivation signal from said braking processing and control means.
(h). Said automatic transmission control means stores the current status of the transmission's gearing mode in a memory means and shifts the automatic transmission to “Park” gearing mode upon receiving said automatic transmission shift signal or shifts the automatic transmission from “Park” gearing mode to the transmission gearing mode previously stored in said memory means upon receiving said automatic transmission reset signal

6. A one-touch braking system for a motored vehicle equipped with an automatic transmission, as stated in claim 5, wherein
(a). Said brake actuation means that operates the service brake system of the vehicle to activate the service brakes of the vehicle upon receiving said brake actuator activation signal or release the service brakes of the vehicle upon receiving said brake actuator deactivation signal from said braking processing and control means.

7. A one-touch braking system for a motored vehicle equipped with an automatic transmission, as stated in claim 5, wherein
(a). The vehicle's braking system is a hydraulic braking system
(b). Said brake actuation means operates the master cylinder of said hydraulic braking system of the vehicle to activate the brakes of the vehicle upon receiving said brake actuator activation signal or deactivate the brakes of the vehicle upon receiving said brake actuator deactivation signal from said braking processing and control means.

8. A one-touch braking system for a motored vehicle equipped with an automatic transmission, as stated in claim 5, wherein
(a). The vehicle's braking system is an electric braking system
(b). Said brake actuation means is the same brake actuation means of said electrical, braking system that activates the brakes of the vehicle upon receiving said brake actuator activation signal or release the brakes of the vehicle upon receiving said brake actuator deactivation signal from said braking processing and control means.

9. A new one-touch braking system for a motored vehicle equipped with a manual transmission comprising:
(a). sends a braking initiation signal out to a braking processing and control means when switched on or sends a braking release signal out to said braking processing and control means when switched off
(b). An accelerator pedal position sensing means that detects if the accelerator pedal is pressed down and sends an accelerator pedal position signal to said braking processing and control means
(c). A brake pedal position sensing means that detects if the brake pedal is pressed down and sends a brake pedal position signal to said braking processing and control means
(d). A vehicle speed sensing means that detects the vehicle speed and sends a vehicle speed signal to said braking processing and control means
(e). Said braking processing and control means receives said one-touch braking signal, said accelerator pedal position signal, said brake pedal position signal, and said vehicle speed signal and checks if the brake pedal is being pressed down by the vehicle operator, the accelerator pedal is not being pressed down, and the vehicle speed is zero and if all yes then it sends a brake actuator activation signal to a brake actuation means and a clutch disengagement signal to a clutch actuation means upon receiving said braking initiation signal
(f). Said braking processing and control means receives said one-touch braking signal, said accelerator pedal position signal, said brake pedal position signal, and said vehicle speed signal and checks if the brake pedal is not being pressed down by the vehicle operator, the accelerator pedal is being pressed down and if all yes then it sends a brake deactivation signal to said brake actuation means and a clutch engagement signal to said clutch control means upon receiving said brake release signal.
(g). Said brake actuation means activates the vehicle's braking system upon receiving said brake actuator activation signal or deactivates the vehicle's braking system upon receiving said brake actuator deactivation signal from said braking processing and control means.
(h). Said clutch actuation means disengages the clutch and locks the clutch in the disengaged position upon receiving said clutch disengagement signal or releases the control of the clutch back to the vehicle operator via a clutch disengagement unlock mechanism means when the vehicle operator presses down the clutch pedal and upon receiving said clutch engagement signal from said braking processing and control means.

10. A one-touch braking system for a motored vehicle equipped with a manual transmission, as stated in claim 9, wherein
(a). Said brake actuation means that operates the service brake system of the vehicle to activate the service brakes of the vehicle upon receiving said brake actuator activation signal or release the service brakes of the vehicle upon receiving said brake actuator deactivation signal from said braking processing and control means.

11. A one-touch braking system for a motored vehicle equipped with a manual transmission, as stated in claim 9, wherein
(a). The vehicle's braking system is a hydraulic braking system
(b). Said brake actuation means operates the master cylinder of said hydraulic braking system of the vehicle to activate the brakes of the vehicle upon receiving said brake actuator activation signal or deactivate the brakes of the vehicle upon receiving said brake actuator deactivation signal from said braking processing and control means.

12. A one-touch braking system for a motored vehicle equipped with an automatic transmission, as stated in claim 9, wherein
(a). The vehicle's braking system is an electric braking system
(b). Said brake actuation means is the same brake actuation means of said electrical braking system that activates the brakes of the vehicle upon receiving said brake actuator activation signal or release the brakes of the vehicle upon receiving said brake actuator deactivation signal from said braking processing and control means

13. A new one-touch braking system for a motored vehicle equipped with a manual transmission with automatic clutch control comprising:
(a). An one-touch braking switch means installed in a vehicle that is conveniently reachable by the operator of the vehicle and sends a braking initiation signal out to a braking processing and control means when switched on or sends a braking release signal out to said braking processing and control means when switched off
(b). An accelerator pedal position sensing means that detects if the accelerator pedal is pressed down and sends an accelerator pedal position signal to said braking processing and control means
(c). A braked pedal position sensing means that detects if the brake pedal is pressed down and sends a brake pedal position signal to said braking processing and control means
(d). A vehicle speed sensing means that detects the vehicle speed and sends a vehicles speed signal to said braking processing and control means
(e). Said braking processing and control means receives said one-touch braking signal, said accelerator pedal position signal, said brake pedal position signal, and said vehicle speed signal and checks if the brake pedal is being pressed down by the vehicle operator, the accelerator pedal is not being pressed down, and the vehicle speed is zero and if all yes then it sends a brake actuator activation signal to a brake actuation means and a transmission disengagement signal to a transmission control means upon receiving said braking initiation signal
(f). Said braking processing and control means receives said one-touch braking signal, said accelerator pedal position signal, said brake pedal position signal, and said vehicle speed signal and checks if the brake pedal is not being pressed down by the vehicle operator, the accelerator pedal is being pressed down and if all yes then it sends a brake deactivation signal to said brake actuation means and a transmission engagement signal to said transmission control means upon receiving said brake release signal
(g). Said brake actuation means activates the vehicle's braking system upon receiving said brake actuator activation signal or deactivates the vehicle's braking system upon receiving said brake actuator deactivation signal from said braking processing and control means.
(h). Said transmission control means operates the automatic clutch and shifts the manual transmission to “Neutral” gearing mode upon receiving said transmission disengagement signal or operates the automatic clutch and shifts the manual transmission from “Neutral” gearing mode to the transmission gearing mode appropriate to launch the vehicle from standstill upon receiving said transmission engagement signal.

14. A one-touch braking system for a motored vehicle equipped with a manual transmission with automatic clutch control, as stated in claim 13, wherein
(a). Said brake actuation means that operates the service brake system of the vehicle to activate the service brakes of the vehicle upon receiving said brake actuator activation signal or release the service brakes of the vehicle upon receiving said brake actuator deactivation signal from said braking processing and control means.

15. A one-touch braking system for a motored vehicle equipped with a manual transmission with automatic clutch control, as stated in claim 13, wherein
(a). The vehicle's braking system is a hydraulic braking system
(b). Said brake actuation means operates the master cylinder of said hydraulic braking system of the vehicle to activate the brakes of the vehicle upon receiving said brake actuator activation signal or deactivate the brakes of the vehicle upon receiving said brake actuator deactivation signal.

16. A one-touch braking system for a motored vehicle equipped with an automatic transmission with automatic clutch control, as stated in claim 13, wherein
(a). The vehicle's braking system is an electric braking system
(b). Said brake actuation means is the same brake actuation means of said electrical braking system that activates the brakes of the vehicle upon receiving said brake actuator activation signal or release the brakes of the vehicle upon receiving said brake actuator deactivation signal
